(19) United States
(12) Patent Application Publication
(10) Pub. No.: US 2015/0003356 A1
(43) Pub. Date: Jan. 1, 2015

(54) DEMODULATION-REFERENCE-SIGNAL TRANSMISSION METHOD AND DEVICE IN A WIRELESS COMMUNICATION SYSTEM

(71) Applicant: LG ELECTRONICS INC., Seoul (KR)

(72) Inventors: Inkwon Seo, Anyang-si (KR); Hanbyul Seo, Anyang-si (KR); Hakseong Kim, Anyang-si (KR)

(21) Appl. No.: 14/372,187

(22) PCT Filed: Jan. 16, 2013
(86) PCT No.: PCT/KR2013/000314

§ 371 Date: Jul. 14, 2014

Related U.S. Application Data
(60) Provisional application No. 61/587,115, filed on Jan. 16, 2012.
(60) Provisional application No. 61/599,948, filed on Feb. 17, 2012.

(51) Int. Cl. H04L 5/00

(52) U.S. Cl. CPC H04L 5/0058; H04L 5/001; H04L 5/0048
USPC 370/329

(57) ABSTRACT

The present invention concerns a method whereby a base station transmits a demodulation reference signal in a wireless communication system, and the demodulation-reference-signal transmission method comprises the step of transmitting a reference-signal sequence mapped onto a resource element on a carrier wave, wherein the position of the resource element onto which the reference signal sequence has been mapped is set so as to respectively differ in accordance with one or more of: the carrier wave type; wherein a cell-specific reference signal has been transmitted; the multiplexing method; and the position of the resource block where the resource element is contained.

### TECHNICAL FIELD

The present invention relates to a wireless communication system, and more particularly to a method and apparatus for transmitting an enhanced physical downlink signal (E-PDCCH) and a demodulation reference signal (DMRS) for the E-PDCCH.

### BACKGROUND ART

Wireless communication systems have been widely used to provide various kinds of communication services such as voice or data services. Generally, a wireless communication system is a multiple access system that can communicate with multiple users by sharing available system resources (bandwidth, transmission (Tx) power, and the like). A variety of multiple access systems can be used. For example, a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency-Division Multiple Access (SC-FDMA) system, a Multi-Carrier Frequency Division Multiple Access (MC-FDMA) system, and the like.

### DISCLOSURE

### Technical Problem

An object of the present invention is to provide a method and apparatus for transmitting a demodulation reference signal (DMRS), and to provide various embodiments related to the position of resource elements (REs) mapped to the DMRS.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The object of the present invention can be achieved by providing a method for transmitting a demodulation reference signal (DMRS) by a base station (BS) in a wireless communication system including: transmitting a reference signal sequence mapped to a resource elements (REs) on a carrier, wherein a position of RE mapped to the reference signal sequence is differently configured according to at least one of a carrier type, transmission or non-transmission of a cell-specific reference signal, a multiplexing scheme, and a position of a resource block (RB) including the resource elements (REs).

In a second technical aspect of the present invention, a base station (BS) for use in a wireless communication system includes: a transmission (Tx) module; and a processor, wherein the processor is configured to transmit a reference signal sequence mapped to a resource elements (REs) on a carrier, wherein a position of RE mapped to the reference signal sequence is differently configured according to at least one of a carrier type, transmission or non-transmission of a cell-specific reference signal, a multiplexing scheme, and a position of a resource block (RB) including the resource elements (REs).

The first and second technical aspects may include all or some parts of the following items.

If a physical downlink control channel (PDCCH) is not transmitted on the carrier, the resource elements (REs) mapped to the reference signal sequence may be present not only in OFDM symbols (#1, #2) of a first slot, but also in OFDM symbols (#5, #6) of a second slot.

If transmission of a synchronous signal of the base station (BS) is carried out at the last OFDM symbol of a second slot, the resource elements (REs) mapped to the reference signal sequence may be present not only in OFDM symbols (#1, #2) of a first slot, but also in OFDM symbols (#2, #3) of a second slot.

If a physical downlink control channel (PDCCH) and the cell-specific reference signal are not transmitted on the carrier, the resource elements (REs) mapped to the reference signal sequence may be present not only in OFDM symbols (#0, #1) of a first slot, but also in OFDM symbols (#5, #6) of a second slot.

If transmission of a synchronous signal of the base station (BS) is carried out at the last OFDM symbol of a second slot, the resource elements (REs) mapped to the reference signal sequence may be present not only in OFDM symbols (#0, #1) of a first slot, but also in OFDM symbols (#4, #5) of a second slot.

A physical downlink shared channel (PDSCH) transmitted on a subframe including the resource elements (REs) may be demodulated using the reference signal sequence.

The cell-specific reference signal may be transmitted through an antenna port #0.

If a resource block (RB) including the resource elements (REs) corresponds to 6 resource blocks (6 RBs) located at the center part of the entire frequency band, the resource elements (REs) mapped to the reference signal sequence may be present not only in OFDM symbols (#1, #2) of a first slot, but also in OFDM symbols (#2, #3) of a second slot.

If a resource block (RB) including the resource elements (REs) corresponds to the remaining resource blocks other than 6 resource blocks (6 RBs) located at the center part of the entire frequency band, the resource elements (REs) mapped to the reference signal sequence is present not only in OFDM symbols (#0, #1) of a first slot, but also in OFDM symbols (#5, #6) of a second slot.

Specific information, that indicates that the position of RE mapped to the reference signal sequence is differently configured according to the position of resource block (RB) including the resource elements (REs), may be signaled to a user equipment (UE) to which the different configurations of the specific information are applied.

The resource elements (REs) mapped to the reference signal sequence may be present not only in OFDM symbols (#1, #2) of a first slot, but also in OFDM symbols (#4, #5) of a second slot.

The resource elements (REs) mapped to the reference signal sequence may be present not only in OFDM symbols (#0, #1) of a first slot, but also in OFDM symbols (#0, #1) of a second slot.

Downlink control information (DCI) may be transmitted only through an enhanced physical downlink control channel (E-PDCCH) on the carrier.

The carrier may be a secondary component carrier (SCC).

### Advantageous Effects

As is apparent from the above description, the method and apparatus for transmitting a demodulation reference signal (DMRS) according to the embodiments of the present invention can improve channel estimation performance through interpolation during channel estimation based on DMRS.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 exemplarily shows a downlink radio frame structure.

FIG. 2 exemplarily shows a resource grid of one downlink slot.

FIG. 3 exemplarily shows a downlink subframe structure.

FIG. 4 exemplarily shows an uplink subframe structure.

FIG. 5 is a conceptual diagram illustrating carrier aggregation (CA).

FIG. 6 is a conceptual diagram illustrating cross carrier scheduling.

FIG. 7 is a conceptual diagram illustrating a cell-specific reference signal.

FIG. 8 is a conceptual diagram illustrating a demodulation reference signal (DMRS).

FIG. 9 exemplarily shows various kinds of reference signals and a PDCCH.

FIGS. 10 to 14 are conceptual diagrams illustrating demodulation reference signal (DMRS) patterns/configurations according to the embodiments of the present invention.

FIG. 15 is a block diagram illustrating a transceiver apparatus applicable to embodiments of the present invention.

### BEST MODE

The following embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment.

In this specification, embodiments of the present invention are described centering on the data transmission/reception relations between an eNode B and a user equipment. In this case, an eNode B has a meaning of a terminal node of a network directly communicating with a user equipment. In this disclosure, a specific operation explained as performed by an eNode B may be performed by an upper node of the eNode B in some cases.

In particular, in a network constructed with a plurality of network nodes including an eNode B, it is apparent that various operations performed for communication with a user equipment can be performed by an eNode B or other network nodes except the eNode B. ‘Base station (BS)’ may be substituted with such a terminology as a fixed station, a Node B, an eNode B (eNB), an access point (AP) and the like. A relay may be substituted with such a terminology as a relay node (RN), a relay station (RS), and the like. And, ‘terminal’ may be substituted with such a terminology as a user equipment (UE), an MS (mobile station), an MSS (mobile subscriber station), an SS (subscriber station), or the like.

Specific terminologies used in the following description are provided to help understand the present invention and the use of the specific terminologies can be modified into a different form in a range of not deviating from the technical idea of the present invention.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Embodiments of the present invention may be supported by the standard documents disclosed in at least one of wireless access systems including IEEE 802 system, 3GPP system, 3GPP LTE system, 3GPP LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document may be supported by the above standard documents.

The following description of embodiments of the present invention may be usable for various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3^{rd} Generation Partnership Project) LTE (long term evolution) is a part of E-UMTS (Evolved UMTS) that uses E-UTRA. The 3GPP LTE adopts OFDMA in downlink (hereinafter abbreviated DL) and SC-FDMA in uplink (hereinafter abbreviated UL). And, LTE-A (LTE-Advanced) is an evolved version of 3GPP LTE. WiMAX may be explained by IEEE 802.16e standard (e.g., WirelessMAN-OFDMA reference system) and advanced IEEE 802.16m standard (e.g., WirelessMAN-OFDMA advanced system). For clarity, the following description mainly concerns 3GPP LTE and LTE-A standards, by which the technical idea of the present invention may be non-limited.

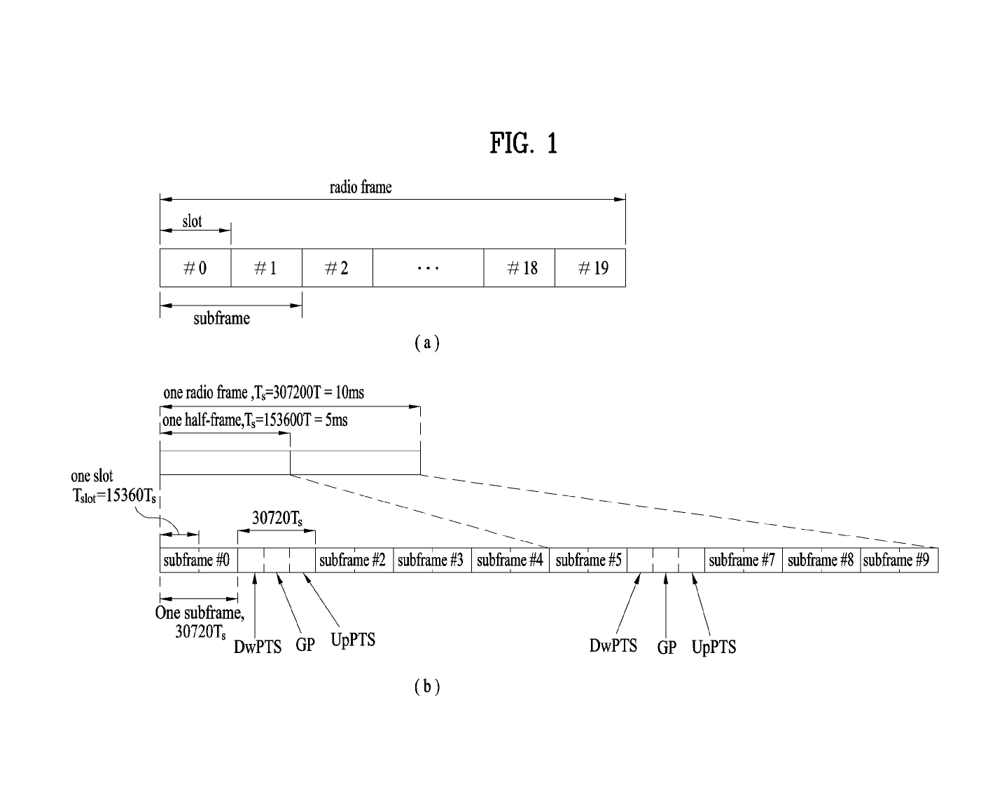

A structure of a radio frame is explained with reference to FIG. 1.

In a cellular OFDM radio packet communication system, UL/DL (uplink/downlink) data packet transmission is performed by a unit of subframe. And, one subframe is defined as a predetermined time interval including a plurality of OFDM symbols. In the 3GPP LTE standard, a type 1 radio frame structure applicable to FDD (frequency division duplex) and a type 2 radio frame structure applicable to TDD (time division duplex) are supported.

FIG. 1 (a) is a diagram for a structure of a type 1 radio frame. A DL (downlink) radio frame includes 10 subframes. Each of the subframes includes 2 slots. And, a time taken to transmit one subframe is defined as a transmission time interval (hereinafter abbreviated TTI). For instance, one subframe may have a length of 1 ms and one slot may have a length of 0.5 ms. One slot may include a plurality of OFDM symbols in time domain and may include a plurality of resource blocks (RBs) in frequency domain. Since 3GPP LTE system uses OFDMA in downlink, OFDM symbol is provided to indicate one symbol interval. The OFDM symbol may be named SC-FDMA symbol or symbol interval. Resource block (RB) is a resource allocation unit and may include a plurality of contiguous subcarriers in one slot.

The number of OFDM symbols included in one slot may vary in accordance with a configuration of CP. The CP may be categorized into an extended CP and a normal CP. For instance, in case that OFDM symbols are configured by the normal CP, the number of OFDM symbols included in one slot may be 7. In case that OFDM symbols are configured by the extended CP, since a length of one OFDM symbol increases, the number of OFDM symbols included in one slot may be smaller than that of the case of the normal CP. In case of the extended CP, for instance, the number of OFDM symbols included in one slot may be 6. If a channel status is unstable (e.g., a UE is moving at high speed), it may be able to use the extended CP to further reduce the inter-symbol interference.

When a normal CP is used, since one slot includes 7 OFDM symbols, one subframe includes 14 OFDM symbols. In this case, first 2 or 3 OFDM symbols of each subframe may be allocated to PDCCH (physical downlink control channel), while the rest of the OFDM symbols are allocated to PDSCH (physical downlink shared channel).

FIG. 1 (b) is a diagram for a structure of a downlink radio frame of type 2. A type 2 radio frame includes 2 half frames. Each of the half frame includes 5 subframes, a DwPTS (downlink pilot time slot), a GP (guard period), and an UpPTS (uplink pilot time slot). Each of the subframes includes 2 slots. The DwPTS is used for initial cell search, synchronization, or a channel estimation in a user equipment. The UpPTS is used for channel estimation of a base station and matching a transmission synchronization of a user equipment. The guard period is a period for eliminating interference generated in uplink due to multi-path delay of a downlink signal between uplink and downlink. Meanwhile, one subframe includes 2 slots irrespective of a type of a radio frame.

The above-described structures of the radio frame are exemplary only. And, the number of subframes included in a radio frame, the number of slots included in the subframe and the number of symbols included in the slot may be modified in various ways.

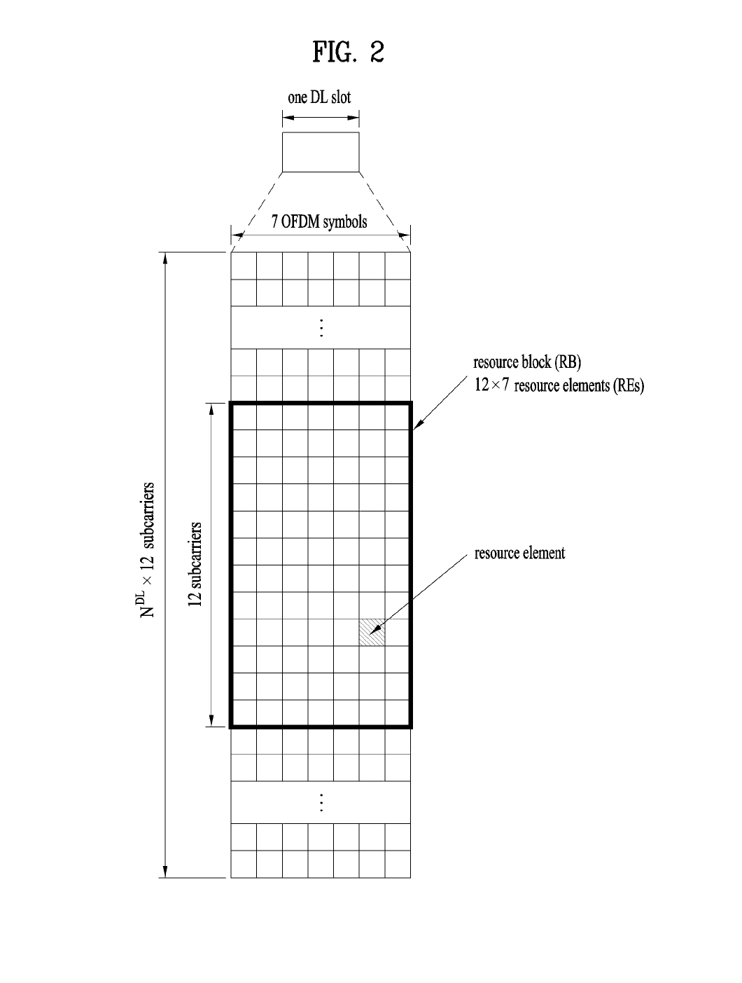

FIG. 2 is a diagram for a resource grid in a downlink slot. Referring to FIG. 2, one downlink (DL) slot includes 7 OFDM symbols and one resource block (RB) includes 12 subcarriers in frequency domain, by which the present invention may be non-limited. For instance, in case of a normal CP (Cyclic Prefix), one slot includes 7 OFDM symbols. In case of an extended CP, one slot may include 6 OFDM symbols. Each element on a resource grid is called a resource element. One resource block includes 12×7 resource elements. The number N^{DL} of resource blocks included in a DL slot may depend on a DL transmission bandwidth. And, the structure of an uplink (UL) slot may be identical to that of the DL slot.

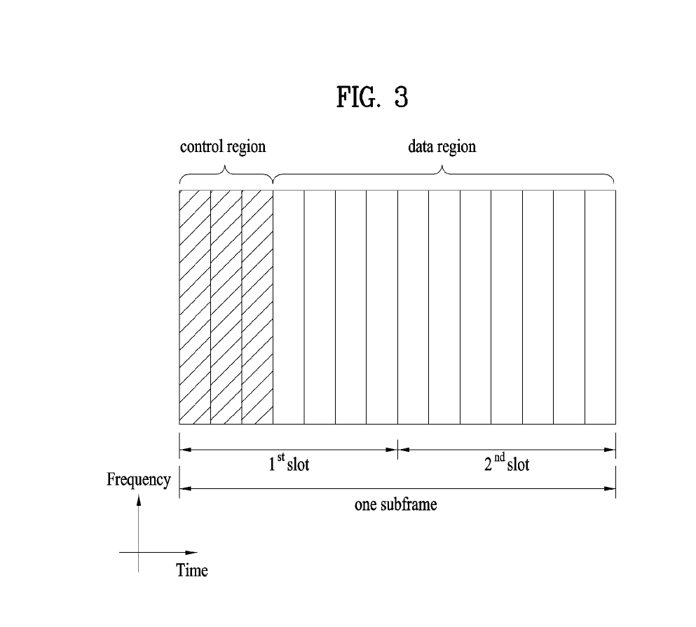

FIG. 3 is a diagram for a structure of a downlink (DL) subframe. Maximum 3 OFDM symbols situated in a head part of a first slot of one subframe correspond to a control region to which control channels are assigned. The rest of OFDM symbols correspond to a data region to which PDSCH (physical downlink shared channel) is assigned. Examples of DL control channels used by 3GPP LTE system may include PCFICH (Physical Control Format Indicator Channel), PDCCH (Physical Downlink Control Channel), PHICH (Physical hybrid automatic repeat request indicator Channel) and the like. The PCFICH is transmitted in a first OFDM symbol of a subframe and includes information on the number of OFDM symbols used for a transmission of a control channel within the subframe. The PHICH is a response channel in response to UL transmission and includes an ACK/NACK signal. Control information carried on PDCCH may be called downlink control information (hereinafter abbreviated DCI). The DCI may include UL scheduling information, DL scheduling information or a UL transmit (Tx) power control command for a random UE (user equipment) group. PDCCH is able to carry resource allocation and transmission format (or called a DL grant) of DL-SCH (downlink shared channel), resource allocation information (or called a UL grant) of UL-SCH (uplink shared channel), paging information on PCH (paging channel), system information on DL-SCH, resource allocation to an upper layer control message such as a random access response transmitted on PDSCH, a set of transmission power control commands for individual user equipments within a random user equipment (UE) group, activation of VoIP (voice over IP) and the like. A plurality of PDCCHs can be transmitted in a control region and a user equipment is able to monitor a plurality of the PDCCHs. PDCCH is configured with the aggregation of at least one or more contiguous CCEs (control channel elements). CCE is a logical assignment unit used to provide PDCCH with a code rate in accordance with a state of a radio channel. CCE corresponds to a plurality of REGs (resource element groups). A format of PDCCH and the number of bits of an available PDCCH are determined depending on correlation between the number of CCEs and a code rate provided by the CCEs. A base station determines PDCCH format in accordance with DCI to transmit to a user equipment and attaches CRC (cyclic redundancy check) to control information. The CRC is masked with a unique identifier (called RNTI (radio network temporary identifier)) in accordance with an owner or usage of PDCCH. If the PDCCH is provided for a specific user equipment, the CRC can be masked with a unique identifier of the user equipment, i.e., C-RNTI (i.e., Cell-RNTI). If the PDCCH is provided for a paging message, the CRC can be masked with a paging indication identifier (e.g., P-RNTI (Paging-RNTI)). If the PDCCH is provided for system information, and more particularly, for a system information block (SIB), the CRC can be masked with a system information identifier (e.g., SI-RNTI (system information-RNTI)). In order to indicate a random access response that is a response to a transmission of a random access preamble of a user equipment, CRC can be masked with RA-RNTI (random access-RNTI).

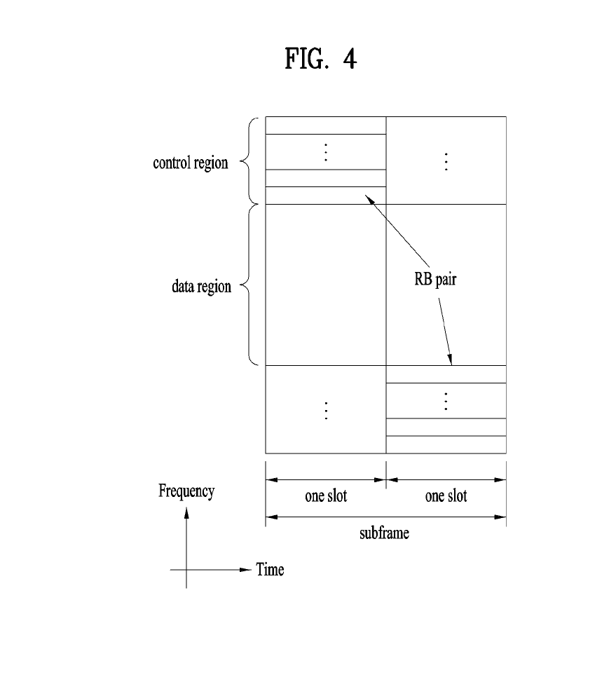

FIG. 4 is a diagram for a structure of an uplink (UL) subframe. Referring to FIG. 4, a UL subframe may be divided into a control region and a data region in frequency domain. A physical UL control channel (PUCCH), which includes UL control information, is assigned to the control region. And, a physical UL shared channel (PUSCH), which includes user data, is assigned to the data region. In order to maintain single carrier property, one user equipment does not transmit PUCCH and PUSCH simultaneously. PUCCH for one user equipment is assigned to a resource block pair (RB pair) in a subframe. Resource blocks belonging to the resource block (RB) pair may occupy different subcarriers in each of 2 slots. Namely, a resource block pair allocated to PUCCH is frequency-hopped on a slot boundary.

Carrier Aggregation (CA)

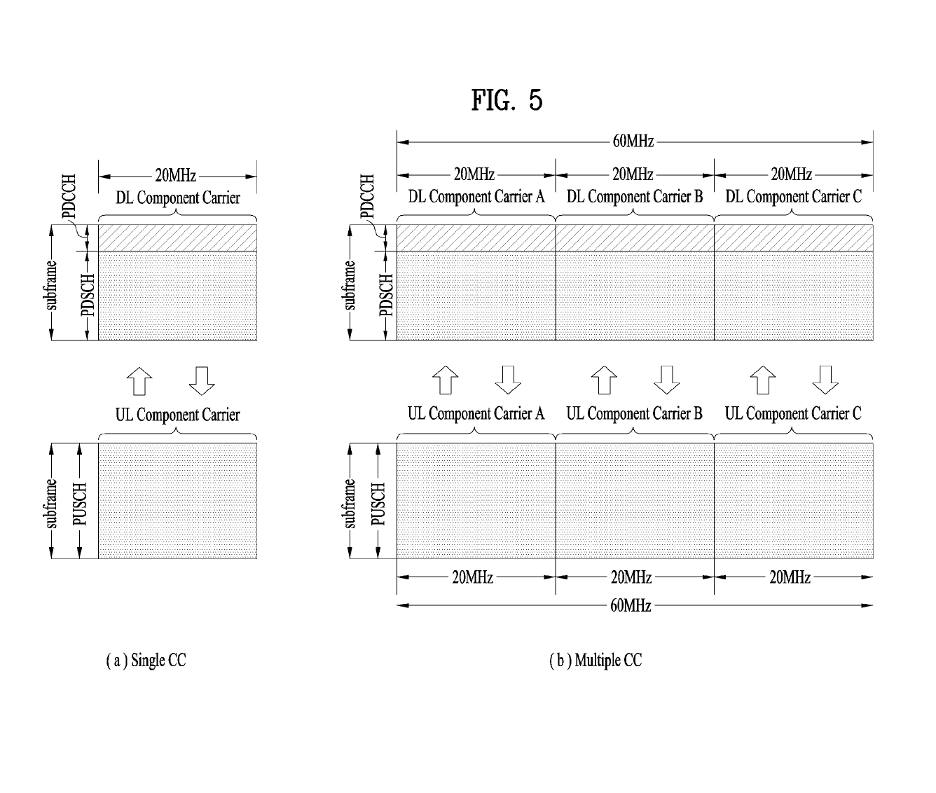

FIG. 5 is a diagram illustrating carrier aggregation (CA). The concept of a cell, which is introduced to manage radio resources in LTE-A is described prior to the CA. A cell may be regarded as a combination of downlink resources and uplink resources. The uplink resources are not essential elements, and thus the cell may be composed of the downlink resources only or both the downlink resources and uplink resources. This is defined in LTE-A release 10, and the cell may be composed of the uplink resources only. The downlink resources may be referred to as downlink component carriers and the uplink resources may be referred to as uplink component carriers. A DL CC and a UL CC may be represented by carrier frequencies. A carrier frequency means a center frequency in a cell.

Cells may be divided into a primary cell (PCell) operating at a primary frequency and a secondary cell (SCell) operating at a secondary frequency. The PCell and SCell may be collectively referred to as serving cells. The PCell may be designated during an initial connection establishment, connection re-establishment or handover procedure of a UE. That is, the PCell may be regarded as a main cell relating to control in a CA environment. A UE may be allocated a PUCCH and transmit the PUCCH in the PCell thereof. The SCell may be configured after radio resource control (RRC) connection establishment and used to provide additional radio resources. Serving cells other than the PCell in a CA environment may be regarded as SCells. For a UE in an RRC_connected state for which CA is not established or a UE that does not support CA, only one serving cell composed of the PCell is present. For a UE in the RRC-connected state for which CA is established, one or more serving cells are present and the serving cells include a PCell and SCells. For a UE that supports CA, a network may configure one or more SCells in addition to a PCell initially configured during connection establishment after initial security activation is initiated.

Carrier aggregation (CA) is described with reference to FIG. 5. CA is a technology introduced to use a wider band to meet demands for a high transmission rate. CA can be defined as aggregation of two or more component carriers (CCs) having different carrier frequencies. FIG. 5(a) shows a subframe when a conventional LTE system uses a single CC and FIG. 5(b) shows a subframe when CA is used. In FIG. 5(b), 3 CCs each having 20 MHz are used to support a bandwidth of 60 MHz. The CCs may be contiguous or non-contiguous.

A UE may simultaneously receive and monitor downlink data through a plurality of DL CCs. Linkage between a DL CC and a UL CC may be indicated by system information. DL CC/UL CC linkage may be fixed to a system or semi-statically configured. Even when a system bandwidth is configured of N CCs, a frequency bandwidth that can be monitored/received by a specific UE may be limited to M (<N) CCs. Various parameters for CA may be configured cell-specifically, UE group-specifically, or UE-specifically.

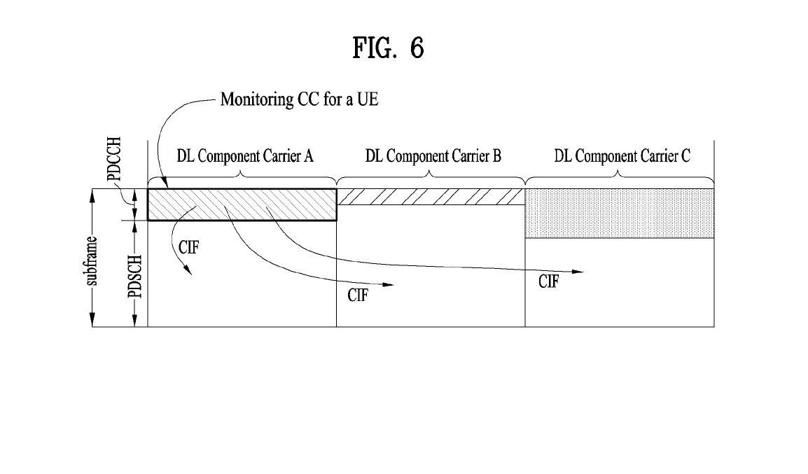

FIG. 6 is a diagram illustrating cross-carrier scheduling. Cross carrier scheduling is a scheme by which a control region of one of DL CCs (Primary CC, PCC) of a plurality of serving cells includes downlink scheduling allocation information the other DL CCs (Secondary CC, SCC) or a scheme by which a control region of one of DL CCs of a plurality of serving cells includes uplink scheduling grant information about a plurality of UL CCs linked with the DL CC.

A carrier indicator field (CIF) is described first.

The CIF may be included in a DCI format transmitted through a PDCCH or not. When the CIF is included in the DCI format, this represents that cross carrier scheduling is applied. When cross carrier scheduling is not applied, downlink scheduling allocation information is valid on a DL CC currently carrying the downlink scheduling allocation information. Uplink scheduling grant is valid on a UL CC linked with a DL CC carrying downlink scheduling allocation information.

When cross carrier scheduling is applied, the CIF indicates a CC associated with downlink scheduling allocation information transmitted on a DL CC through a PDCCH. For example, referring to FIG. 6, downlink allocation information for DL CC B and DL CC C, that is, information about PDSCH resources is transmitted through a PDCCH in a control region of DL CC A. A UE can recognize PDSCH resource regions and the corresponding CCs through the CIF by monitoring DL CC A.

Whether or not the CIF is included in a PDCCH may be semi-statically set and UE-specifically enabled according to higher layer signaling. When the CIF is disabled, a PDCCH on a specific DL CC may allocate a PDSCH resource on the same DL CC and assign a PUSCH resource on a UL CC linked with the specific DL CC. In this case, the same coding scheme, CCE based resource mapping and DCI formats as those used for the conventional PDCCH structure are applicable.

When the CIF is enabled, a PDCCH on a specific DL CC may allocate a PDSCH/PUSCH resource on a DL/UL CC indicated by the CIF from among aggregated CCs. In this case, the CIF can be additionally defined in existing PDCCH DCI formats. The CIF may be defined as a field having a fixed length of 3 bits, or a CIF position may be fixed irrespective of DCI format size. In this case, the same coding scheme, CCE based resource mapping and DCI formats as those used for the conventional PDCCH structure are applicable.

Even when the CIF is present, an eNB can allocate a DL CC set through which a PDCCH is monitored. Accordingly, blinding decoding overhead of a UE can be reduced. A PDCCH monitoring CC set is part of aggregated DL CCs and a UE can perform PDCCH detection/decoding in the CC set only. That is, the eNB can transmit the PDCCH only on the PDCCH monitoring CC set in order to schedule a PDSCH/PUSCH for the UE. The PDCCH monitoring DL CC set may be configured UE-specifically, UE group-specifically or cell-specifically. For example, when 3 DL CCs are aggregated as shown in FIG. 6, DL CC A can be configured as a PDCCH monitoring DL CC. When the CIF is disabled, a PDCCH on each DL CC can schedule only the PDSCH on DL CC A. When the CIF is enabled, the PDCCH on DL CC A can schedule PDSCHs in other DL CCs as well as the PDSCH in DL CC A. When DL CC A is set as a PDCCH monitoring CC, DL CC B and DL CC C do not transmit PDSCHs.

Reference signal (RS)

When packets are transmitted in a wireless communication system, since the transmitted packets are transmitted via a radio channel, signal distortion may occur in a transmission process. In order to enable a receiver to accurately receive the distorted signal, distortion of the received signal should be corrected using channel information. In order to detect the channel information, a method of transmitting a signal which is known to a transmitter and a receiver and detecting channel information using a distortion degree when the signal is received via the channel is mainly used. The signal is referred to as a pilot signal or a reference signal.

If data is transmitted and received using multiple antennas, a channel state between each transmission antenna and each reception antenna should be known in order to accurately receive a signal. Accordingly, a reference signal is present per transmission antenna and, more particularly, per antenna port.

The reference signal may be divided into an uplink reference signal and a downlink reference signal. In a current LTE system, the uplink reference signal includes:

i) a demodulation reference signal (DM-RS) for channel estimation for coherent demodulation of information transmitted via a PUSCH and a PUCCH, and

ii) a sounding reference signal (SRS) for measuring uplink channel quality of a network at different frequencies at the BS.

The downlink reference signal includes:

i) a cell-specific reference signal (CRS) shared by all UEs in the cell,

ii) a UE-specific reference signal for a specific UE,

iii) a demodulation-reference signal (DM-RS) transmitted for coherent demodulation if a PDSCH is transmitted,

iv) a channel state information-reference signal (CSI-RS) for delivering channel state information (CSI) if a downlink DMRS is transmitted,

v) an MBSFN reference signal transmitted for coherent demodulation of a signal transmitted in a multimedia broadcast single frequency network (MBSFN) mode, and

vi) a positioning reference signal used to estimate geographical position information of the UE.

The reference signals may be broadly divided into two reference signals according to the purpose thereof. There are a reference signal for acquiring channel information and a reference signal used for data demodulation. Since the former reference signal is used when the UE acquires channel information in downlink, the reference signal is transmitted over a wide band and even a UE which does not receive downlink data in a specific subframe should receive the reference signal. This reference signal is used even in handover. The latter reference signal is sent by the BS along with resources in downlink. The UE receives the reference signal to perform channel measurement and data modulation. This reference signal is transmitted in a region in which data is transmitted.

The CRS is used for two purposes such as channel information acquisition and data demodulation and the UE-specific reference signal is used only for data demodulation. The CRS is transmitted per subframe over a wide band and reference signals for a maximum of four antenna ports are transmitted according to the number of transmit antennas of the base station.

For example, if the number of transmit antennas of the base station is 2, CRSs for antenna ports 0 and 1 are transmitted and, if the number of transmit antennas of the base station is 4, CRSs for antenna ports 0 to 3 are transmitted.

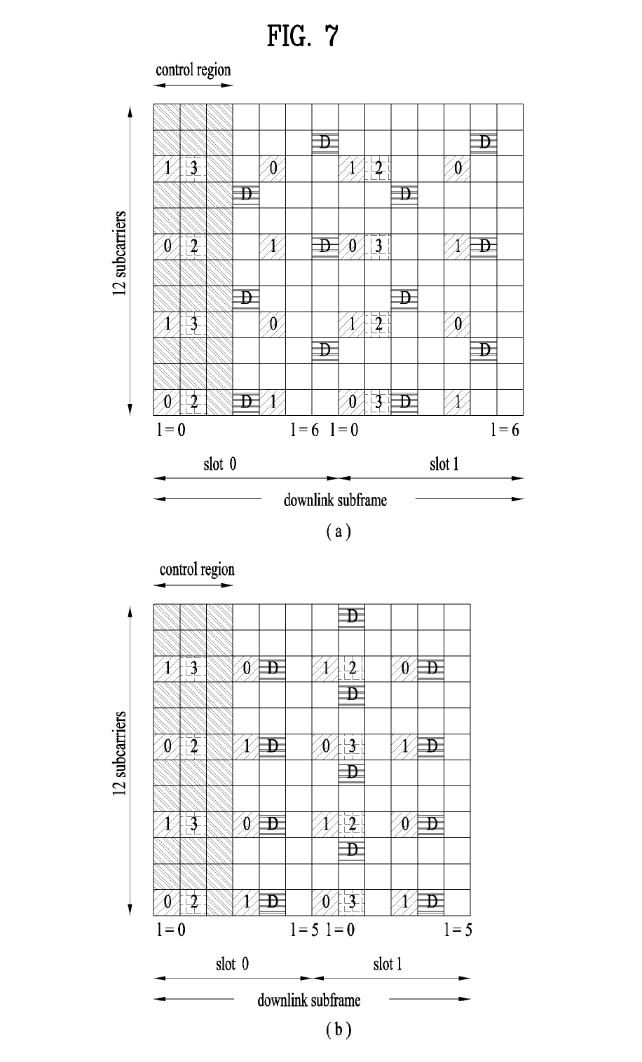

FIG. 7 is a diagram illustrating a pattern in which CRSs and DRSs defined in a legacy 3GPP LTE system (e.g., release-8) are mapped onto resource block (RB) pairs. A downlink RB pair as a mapping unit of a reference signal may be expressed by one subframe on a time axis and 12 subcarriers on a frequency axis. That is, one RB pair has 14 OFDM symbols in case of a normal CP (FIG. 7(a)) and 12 OFDM symbols in case of an extended CP (FIG. 7(b)).

FIG. 7 shows locations of the reference signals on the RB pairs in a system in which the base station (BS) supports four transmit antennas. In FIG. 7, resource elements (REs) denoted by “0”, “1”, “2” and “3” represent the locations of the CRSs for antenna port indices 0, 1, 2 and 3. Meanwhile, the RE denoted by “D” represents the location of the DMRS.

Demodulation Reference Signal (DMRS)

DMRS is a reference signal that is defined by a UE to implement channel estimation for PDSCH. DMRS may be used in Tx ports 7, 8, and 9. In the initial stages, although DMRS has been defined for transmission of a single layer corresponding to an antenna port 5, the DMRS has been extended for spatial multiplexing of a maximum of 8 layers. DMRS is transmitted only for a single specific UE as can be seen from a UE-specific reference signal (RS) corresponding to a different name of DMRS. Accordingly, DMRS can be transmitted only in an RB in which PDSCH for the specific UE is transmitted.

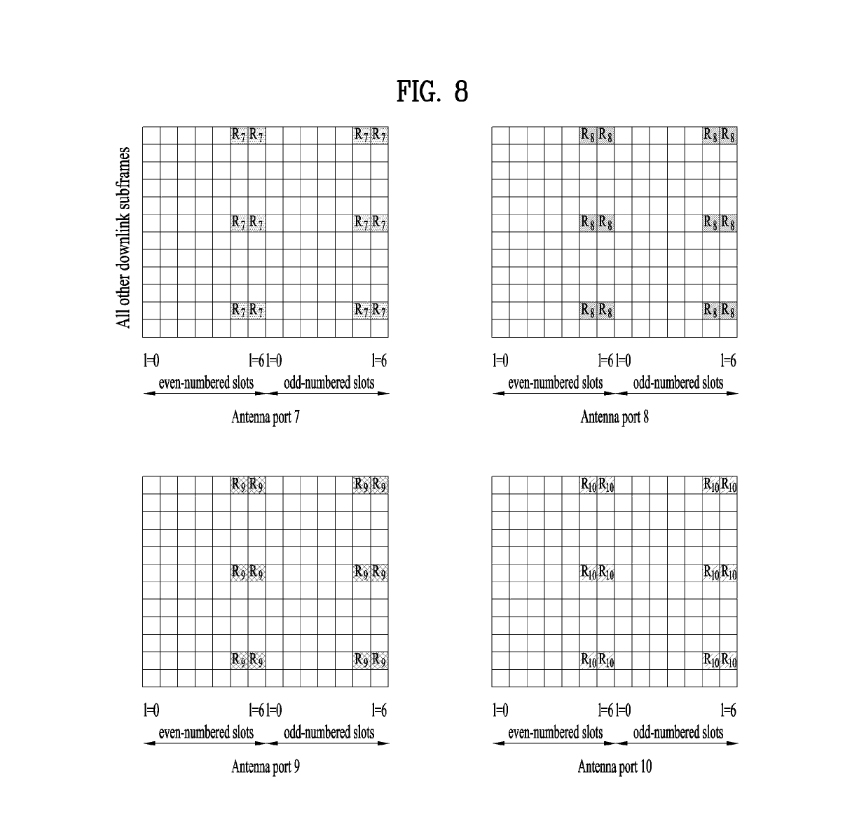

DMRS generation for a maximum of 8 layers will hereinafter be described in detail. In case of DMRS, a reference signal sequence r(m) generated by Equation 5 may be mapped to a complex-valued modulation symbols α_{k,l}^{(p)} obtained by Equation 6. FIG. 8 shows that DMRS is mapped to a resource grid of a subframe in case of a general CP, and relates to antenna ports 7 to 10.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix} \qquad [ Equation 1 ]$$

In Equation 1, r(m) is a reference signal sequence, c(i) is a pseudo-random sequence, and N_{RB}^{max,DL} is a maximum number of RBs of a downlink bandwidth.

$${a}_{k , l}^{( p )} = {w}_{p} ( {l}^{′} ) \cdot r ( 3 \cdot {l}^{′} \cdot {N}_{RB}^{max , DL} + 3 \cdot {n}_{PRB} + {m}^{′} ) \\ {w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 7 , 8 , 11 , 13 \} \\ 0 & p ∈ \{ 9 , 10 , 12 , 14 \}\end{matrix} \\ l = \{ \begin{matrix}{l}^{′} mod 2 + 2 & Case of special subframe configuration 3 , 4 , 8 , 9 \\ {l}^{′} mod 2 + 2 + 3 ⌊ {l}^{′} / 2 ⌋ & Case of special subframe configuration 1 , 2 , 6 , 7 \\ {l}^{′} mod 2 + 5 & Case in which special subframe is not given\end{matrix} \\ {l}^{′} = \{ \begin{matrix}0 , 1 , 2 , 3 & {n}_{s} mod 2 = 0 , C ase of special subframe configuration 1 , 2 , 6 , 7 \\ 0 , 1 & {n}_{s} mod 2 = 0 , Case in which special subframe configurations 1 , 2 , 6 , 7 are not given \\ 2 , 3 & {n}_{s} mod 2 = 1 , Case in which special subframe configurations 1 , 2 , 6 , 7 are not given\end{matrix} \\ {m}^{′} = 0 , 1 , 2 \qquad [ Equation 2 ]$$

As can be seen from Equation 2, an orthogonal sequence w̅ₚ(i) shown in the following Table 1 is applied to the reference signal sequence r(m) when r(m) is mapped to a complex modulation symbol.

TABLE 1

| Antenna port ^{p} | [ w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

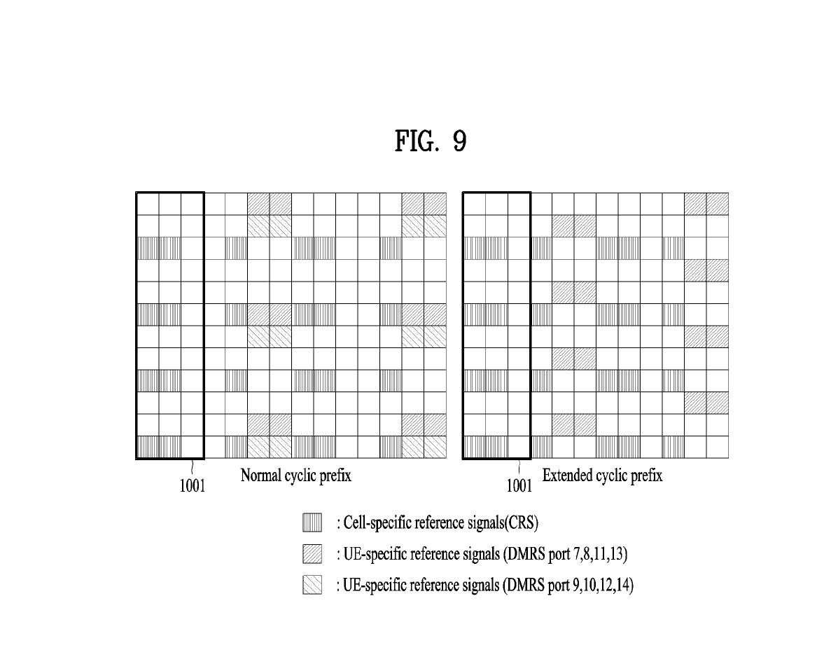

FIG. 9 exemplarily shows a specific region in which it is possible to use CRS, DMRS, and PDCCH, on a single PRB pair. In FIG. 9, PDCCH may be exemplarily transmitted on an OFDM symbol 1001 of a first slot (#0˜#2) of a subframe. Referring to FIG. 9, DMRS for use in the legacy LTE/LTE-A may be present at OFDM symbols of a first slot (#5, #6) and a second slot (#5, #6) in consideration of a PDCCH transmission region. (It is assumed that the index of an OFDM symbol of each slot is composed of #0 to #6.) In this case, when channel estimation is performed to demodulate most REs of the first slot, this channel estimation may be achieved through extrapolation. (A first channel estimation scheme for resources (as can be seen from a normal CP case of FIG. 9, OFDM symbols (#0˜#4) of the second slot may correspond to the resources) located between RSs may be referred to as interpolation, and a second channel estimation scheme for both RS and resource located outside of the RS may be referred to as extrapolation.) In this case, if PDCCH is not transmitted (as in SCC, EPDCCH stand alone, new-carrier type, etc.), DMRS configuration may be changed in a manner that interpolation-based channel estimation having higher performance than extrapolation-based channel estimation can be achieved, instead of using the legacy DMRS configuration without change.

Therefore, the present invention provides a reference signal (RS) structure that can improve channel estimation performance of the corresponding subframe when there is no control signal in the legacy subframe structure (i.e., when PDCCH is not transmitted). To this end, the position of RE mapped to DMRS (more specifically, the above-mentioned reference signal sequence) may be different from the position of another RE mapped to DMRS in the legacy LTE/LTE-A system, according to carrier type, transmission or non-transmission of CRS, a multiplexing scheme, etc. (Hereinafter, a legacy orthogonal sequence of DMRS may be used without change. In addition, a detailed description of the drawings of the present invention will focuse on the case of a normal CP).

In this case, the term “carrier type” may be identified according to whether an object carrier is a carrier needed for PDCCH transmission. In more detail, in case of using a Secondary Component Carrier (SCC) (also called an extension carrier or additional carrier), PDCCH need not always be transmitted on SCC during cross-carrier scheduling. In this case, the position of RE mapped to DMRS may be changed. In another example, even when control information is transmitted only using EPDCH instead of using a PDCCH at a carrier (or a specific subframe) (i.e., EPDCCH stand-alone case), the position of RE mapped to DMRS may be changed. Alternatively, the above-mentioned example may also be applied to a new carrier type that is under development without difficulty.

In addition, the term “CRS” from among “transmission or non-transmission of CRS” may correspond to a CRS that is transmitted through an antenna port 0(1) from among the above-mentioned CRSs. In addition, CRS may be similar in structure to another CRS transmitted at Antenna Port 0. Alternatively, a tracking reference signal (TRS) transmitted to the CRS transmission position of the antenna port 0 may correspond to the above CRS. (In this case, TRS may be mapped to the CRS transmission position of the antenna port 0 on a subframe, a TRS transmission period may be different from a CRS transmission period (e.g., 5 ms), and cannot be used in PDSCH demodulation or the like.)

Further, this RE position change (or RE position shift) may be differently established according to the RB/PRB pair including an RE needed for DMRS transmission.

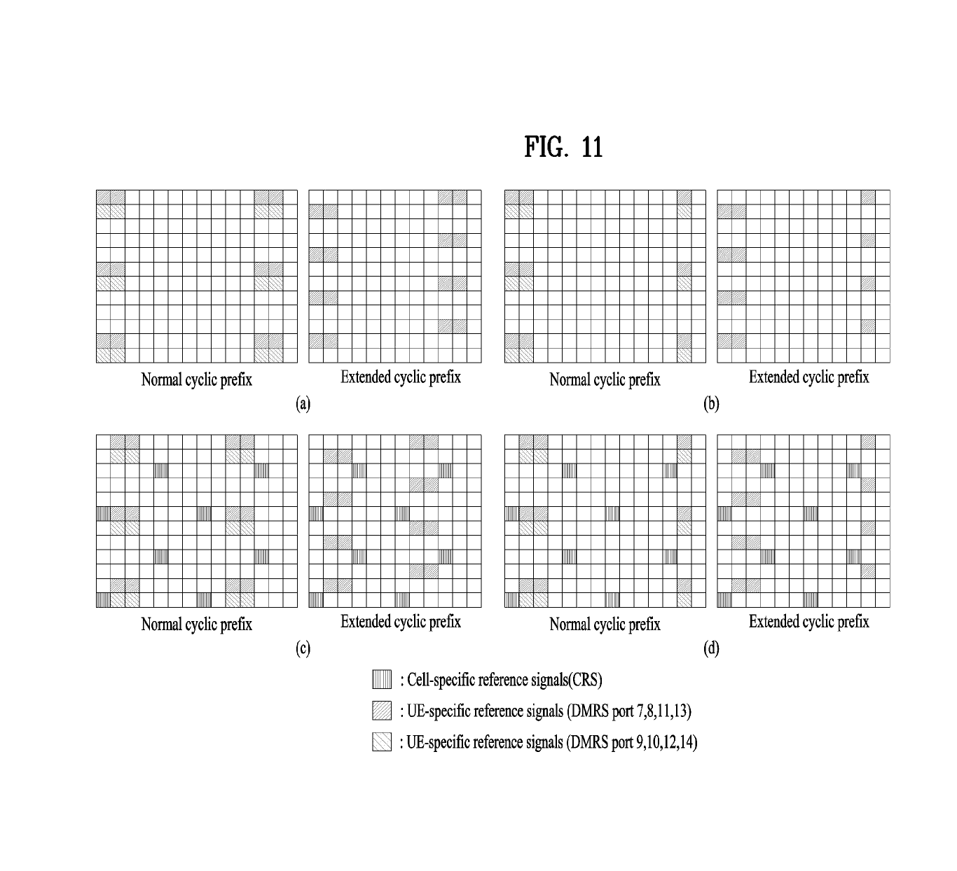

The above-mentioned proposal of the present invention will hereinafter be described with reference to FIGS. 11 to 14.

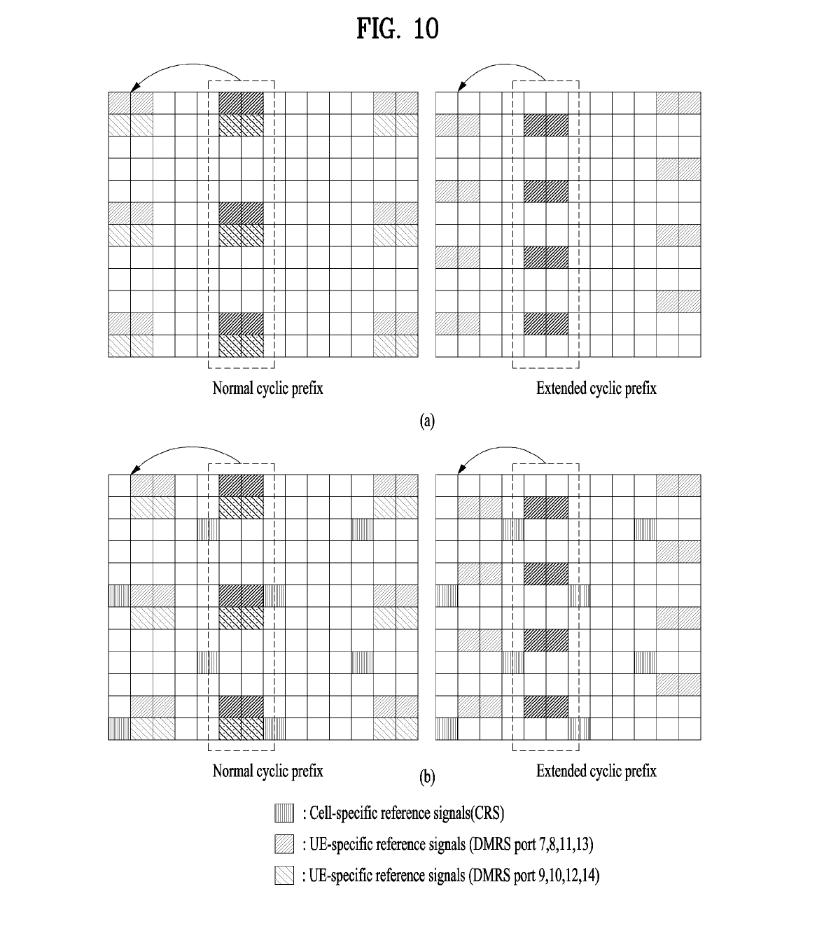

FIG. 10 exemplarily shows the position of RE mapped to DMRS when PDCCH is not transmitted.

Referring to FIG. 10(a), it can be recognized that DMRSs mapped to OFDM symbols (#5, #6) of a first slot of the legacy subframe and DMRSs mapped to OFDM symbols (#5, #6) of a second slot of the legacy subframe, especially, the position of RE mapped to DMRS in the first slot, have been changed (or shifted) to other OFDM symbols (#0, #1). Since it is assumed that PDCCH is not transmitted, the RE position mapped to DMRS is shifted to an OFDM symbol through which the legacy PDCCH is transmitted so that channel estimation performance caused by interpolation can be improved.

FIG. 10(b) shows an exemplary case in which CRS transmission (timing offset, fine-tuning of a frequency offset, etc.) is considered in the case of FIG. 10(a). Specifically, the exemplary case of FIG. 10(b) may consider CRS transmitted through antenna port #0 or TRS transmitted at the same RE as in the CRS. Assuming that CRS is transmitted and the CRS antenna port is based on the eNB Tx antenna, i.e., assuming that plural antenna ports are used, the legacy DMRS configuration may be used for DMRS-based channel estimation.

Subsequently, referring to FIG. 10(b), if PDCCH is not transmitted and CRS is transmitted, DMRS may be mapped to RE that is present at OFDM symbols (#1, #2) of the first slot of the subframe. In other words, RE mapped to DMRS in a legacy first slot may be shifted to the left by four sections (or four blanks) on the basis of an OFDM symbol. In this case, the present invention can guarantee CRS transmission, and can also improve channel estimation performance caused by interpolation.

FIG. 11 exemplarily shows the RE position mapped to DMRS when the case of FIG. 10 further considers system information (SI). In LTE/LTE-A, DMRS-based PDSCH transmission cannot be applied to the UE in which a transmission region of PBCH (Physical Broadcast Channel) and PSS (Primary Synchronous Signal)/SSS (Secondary Synchronous Signal) overlaps with allocated resources in the corresponding subframe, because PBCH and PSS/SSS collide with DMRS configuration. In this case, CRS-based PDSCH transmission is carried out, (if channel feedback information of the UE is valid) such that the CRS-based PDSCH transmission has lower performance than DMRS-based PDSCH transmission. The above-mentioned problem can be largely solved by the shifting operation of RE mapped to DMRS shown in FIG. 11. In case of TDD, since SSS is transmitted at the last symbol of a second slot, the SSS needs to be further considered, such that DMRS mapping can be carried out as shown in FIG. 11.

In more detail, as can be seen from FIG. 11(a), if PDCCH is not transmitted and a synchronization signal (SSS) is transmitted to the last OFDM symbol of the subframe (i.e., if TDD is applied), RE mapped to DMRS may be present not only in OFDM symbols (#0, #1) of a first slot of the subframe but also in OFDM symbols (#4, #5) of a second slot of the subframe. Alternatively, as shown in FIG. 11(b), DMRS may not be mapped to the last OFDM symbol of the second slot. However, the number of UEs capable of being multiplexed may be reduced as necessary.

Referring to FIG. 11(c), assuming that CRS is transmitted and TDD is applied without PDCCH transmission, RE mapped to DMRS may be present not only in OFDM symbols (#1, #2) of a first slot of the subframe, but also in OFDM symbols (#2, #3) of a second slot of the subframe. Alternatively, as shown in FIG. 11(d), DMRS may not be mapped to the last OFDM symbol of the second slot. (The DMRS mapping schemes of FIGS. 11(b) and 11(d) may be implemented by an exemplary method in which the last element of a spread code having a spreading factor of 4 is not transmitted.)

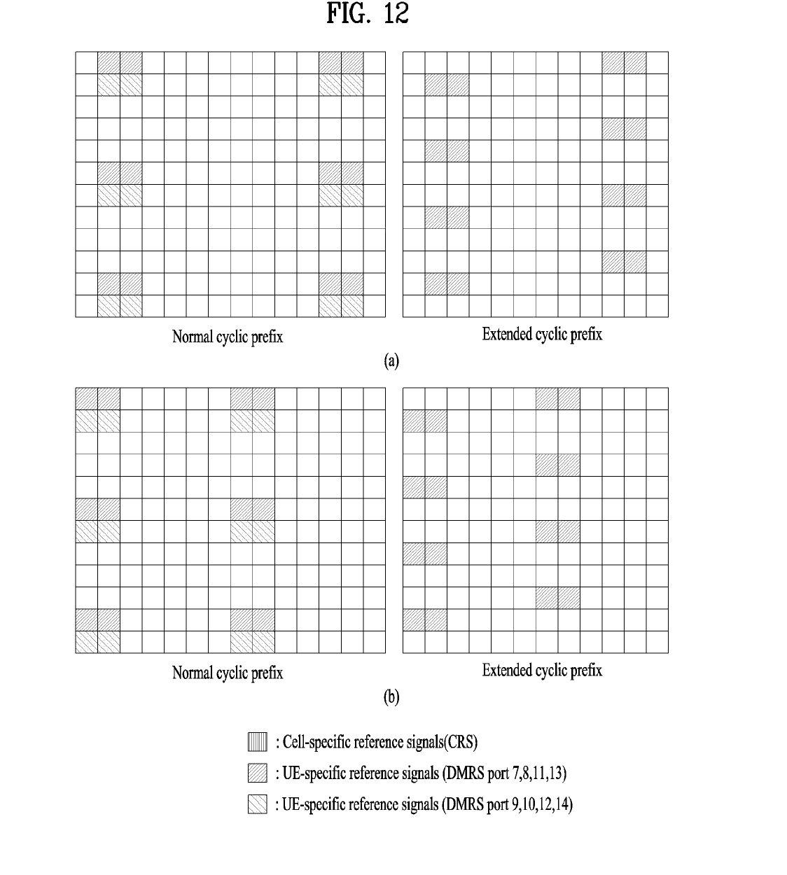

As can be seen from FIGS. 10 and 11, the position of RE mapped to DMRS may be configured as shown in FIG. 12. In more detail, as shown in FIG. 12a, RE mapped to DMRS may be symmetrically configured in such a manner that the RE may be present not only in OFDM symbols (#1, #2) of a first slot of the subframe, but also in OFDM symbols (#4, #5) of a second slot of the subframe.

In FIG. 12(b), RE mapped to DMRS may be present not only in OFDM symbols (#0, #1) of a first slot of the subframe, but also in OFDM symbols of a second slot (#0, #1) of the subframe. As a result, the above-mentioned case of FIG. 12(b) can obviate the legacy DMRS problem in which the entirety of one slot should be received for channel estimation implementation because the legacy DMRS is located at the end of the slot, such that channel estimation can be achieved within a short time.

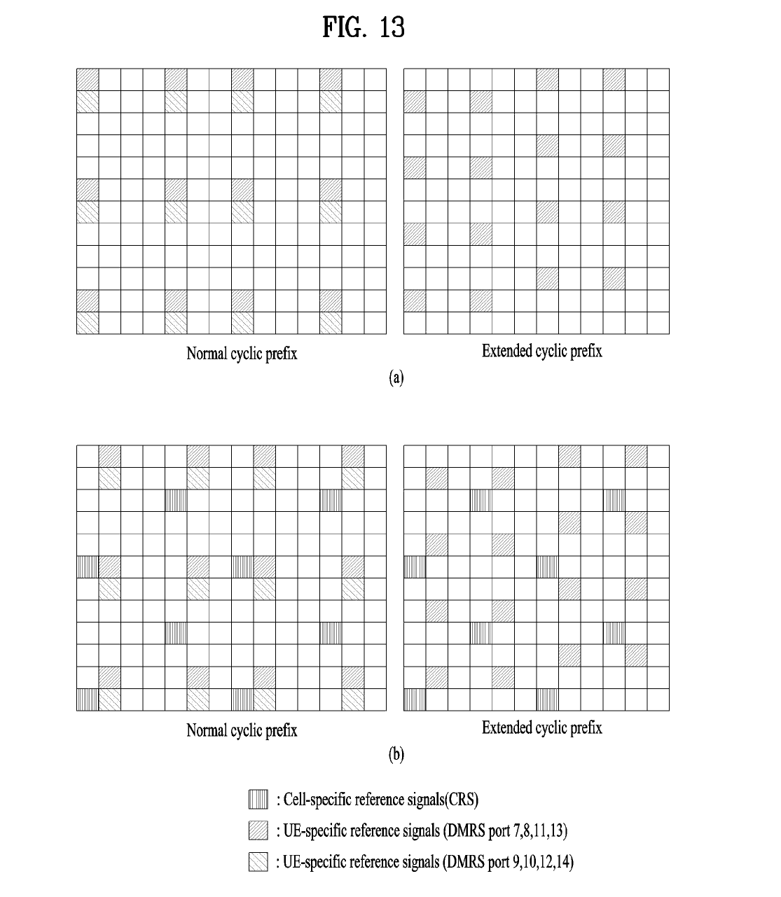

In order to more uniformly distribute a DMRS within the subframe, an exemplary case of FIG. 13 may be implemented. This means that the legacy DMRS configuration has been uniformly distributed within the subframe.

DMRS patterns shown in FIGS. 10 to 13 may be selected in consideration of channel state or additional signaling (for example, CRS, CSI-RS, Paging, PSS, SSS, PBCH, etc.) of the corresponding subframe, and the DMRS patterns may be signaled to the UE through higher layer signaling such as RRC signaling. In addition, it may also be possible to signal specific information as to which subframe will be applied to the corresponding DMRS pattern.

Meanwhile, the position change (or shift) of RE mapped to DMRS may be differently configured according to the RB/PRB pair including an RE needed for DMRS transmission. In other words, the legacy DMRS pattern and the proposed DMRS pattern may be classified according to unit frequencies in a frequency domain.

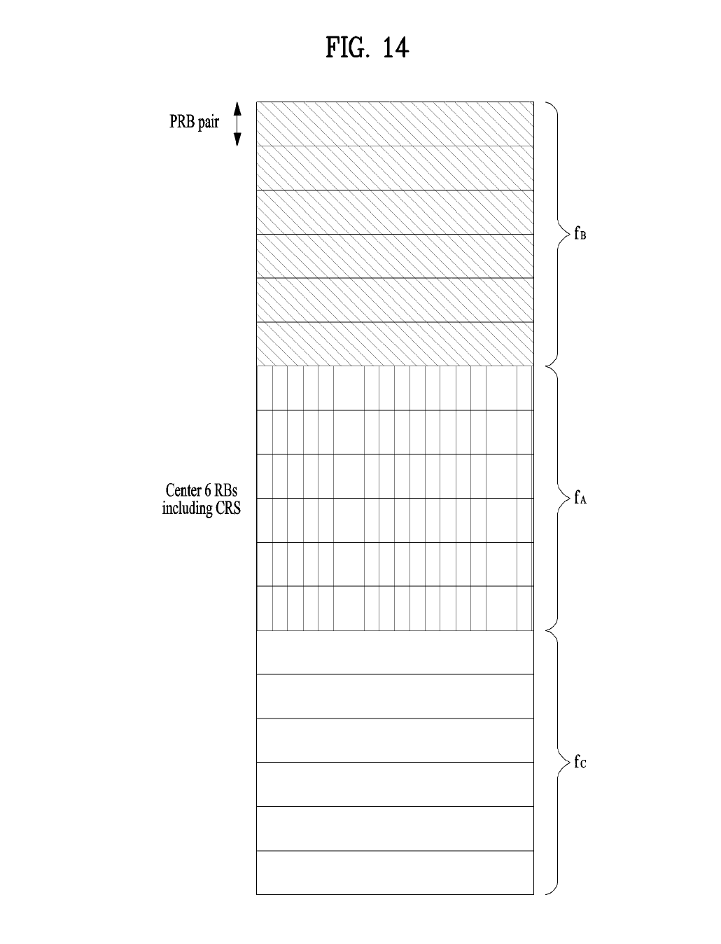

An associated example is shown in FIG. 14. In FIG. 14, it is assumed that CRS is transmitted only to 6RBs (fA) located at the center part of the entire system frequency band so as to perform timing tracking or the like. In this case, DMRS pattern/configuration shown in FIGS. 10(b), 11(c), 11(d), 13(b), etc. may be used in 6RBs (fA) located at the center part of the entire system frequency band. In other words, associated DMRS configuration may be used in the case in which only CRS is transmitted without PDCCH transmission. However, the scope or spirit of the present invention is not limited thereto, and DMRS configuration of the legacy LTE/LTE-A systems may be used without change.

Unlike DMRS pattern/configuration used in 6RBs (fA) located at the center part of the entire system frequency band, other DMRS pattern/configuration may be used in the remaining frequency band (both of fB and fC, or each of fB and fC) other than the 6RBs (fA). For example, DMRS pattern/configuration shown in FIG. 10(a) may correspond to the above DMRS pattern/configuration. However, the scope or spirit of the present invention is not limited thereto, the above-mentioned various DMRS patterns/configurations may be applied to the present invention, or DMRS configuration of the legacy LTE/LTE-A system may also be used without change.

As described above, if DMRS pattern/configuration is separately applied on a frequency axis, it is necessary to inform the UE of specific information as to which DMRS pattern/configuration is used for the corresponding frequency band. As a signaling method, RRC signaling or the like may be used. If necessary, individual application of the above signaling may be dynamically, semi-statically, or statically signaled. In addition, one of the DMRS pattern/configuration of the LTE/LTE-A system and the other DMRS pattern may be used. In addition, only when additional signaling is needed, the above-mentioned DMRS pattern configuration may be used. In addition, signaling information that commands the UE to perform CRS-based channel estimation may be needed.

In addition, DMRS pattern/configuration may be UE-specifically applied, and this resultant information may be signaled to this specific UE. In more detail, assuming that a specific frequency band (e.g., fB, fC) from among the entire frequency band is used for a specific UE, the above-mentioned DMRS pattern/configuration may be applied only to the specific frequency band.

Alternatively, DMRS pattern/configuration may be separately applied to a specific frequency band allocated to a specific UE. For example, if specific frequency bands (fA, fC) are allocated to this specific UE, a DMRS pattern/configuration obtained by the result of CRS transmission may be applied to the frequency band (fA), and a DMRS pattern/configuration different from that of the frequency band (fA) may be applied to the frequency band (fC). Although the above-mentioned case has disclosed that different DMRS patterns/configurations are applied to a specific frequency band allocated to the specific UE for convenience of description and better understanding of the present invention, it should be noted that the same DMRS pattern/configuration can also be applied to the specific frequency band. In other words, if 6RBs located at the center part of the entire system frequency band and another frequency band other than the 6RBs are allocated to a specific UE, it may be preferable that CRS-based DMRS configuration/pattern be applied to 6RBs located at the center part of the entire system frequency band. In this case, DMRS configuration/pattern based on CRS may also be applied to another frequency band without change.

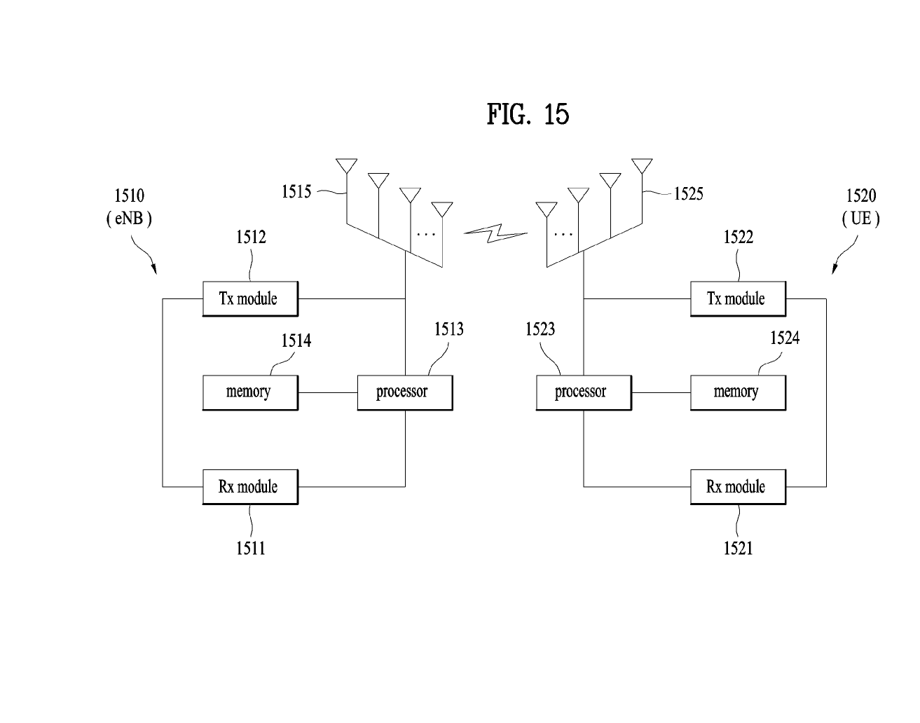

FIG. 15 is a block diagram illustrating a transmission point apparatus and a UE device according to embodiments of the present invention.

Referring to FIG. 15, the transmission point apparatus 1510 according to the present invention may include a reception (Rx) module 1511, a transmission (Tx) module 1512, a processor 1513, a memory 1514, and a plurality of antennas 1515. The plurality of antennas 1515 indicates a transmission point apparatus for supporting MIMO transmission and reception. The reception (Rx) module 1511 may receive a variety of signals, data and information on an uplink starting from the UE. The Tx module 1512 may transmit a variety of signals, data and information on a downlink for the UE. The processor 1513 may provide overall control to the transmission point apparatus 1510.

The processor 1513 of the transmission (Tx) point apparatus 1510 according to one embodiment of the present invention can process various operations needed for the above-mentioned measurement report, handover, random access, etc.

The processor 1513 of the transmission point apparatus 1510 processes information received at the transmission point apparatus 1510 and transmission information to be transmitted externally. The memory 1514 may store the processed information for a predetermined time. The memory 1514 may be replaced with a component such as a buffer (not shown).

Referring to FIG. 15, the UE device 1520 may include an Rx module 1521, a Tx module 1522, a processor 1523, a memory 1524, and a plurality of antennas 1525. The plurality of antennas 1525 indicates a UE apparatus supporting MIMO transmission and reception. The Rx module 1521 may receive downlink signals, data and information from the BS (eNB). The Tx module 1522 may transmit uplink signals, data and information to the BS (eNB). The processor 1523 may provide overall control to the UE device 1520.

The processor 1523 of the UE device 1520 according to one embodiment of the present invention can process various operations needed for the above-mentioned measurement report, handover, random access, etc.

The processor 1523 of the UE device 1520 processes information received at the UE apparatus 1520 and transmission information to be transmitted externally. The memory 1524 may store the processed information for a predetermined time. The memory 1524 may be replaced with a component such as a buffer (not shown).

The specific configurations of the transmission point apparatus and the UE device may be implemented such that the various embodiments of the present invention are performed independently or two or more embodiments of the present invention are performed simultaneously. Redundant matters will not be described herein for clarity.

The description of the transmission point apparatus 1510 shown in FIG. 15 may be applied to a relay node (RN) acting as a DL transmission entity or UL reception entity without departing from the scope or spirit of the present invention. In addition, the description of the UE device 1520 may be applied to a relay node (RN) acting as a UL transmission entity or DL reception entity without departing from the scope or spirit of the present invention.

The above-described embodiments of the present invention can be implemented by a variety of means, for example, hardware, firmware, software, or a combination thereof

In the case of implementing the present invention by hardware, the present invention can be implemented with application specific integrated circuits (ASICs), Digital signal processors (DSPs), digital signal processing devices (DSPDs), programmable logic devices (PLDs), field programmable gate arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. Software code may be stored in a memory to be driven by a processor. The memory may be located inside or outside of the processor, so that it can communicate with the aforementioned processor via a variety of well-known parts.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

Those skilled in the art will appreciate that the present invention may be carried out in other specific ways than those set forth herein without departing from the spirit and essential characteristics of the present invention. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. Also, it will be obvious to those skilled in the art that claims that are not explicitly cited in the appended claims may be presented in combination as an exemplary embodiment of the present invention or included as a new claim by subsequent amendment after the application is filed.

### INDUSTRIAL APPLICABILITY

The embodiments of the present invention can be applied to a variety of mobile communication systems.

1. A method for transmitting a demodulation reference signal (DMRS) by a base station (BS) in a wireless communication system, comprising:
transmitting a reference signal sequence mapped to a resource elements (REs) on a carrier,
wherein a position of RE mapped to the reference signal sequence is differently configured according to at least one of a carrier type, transmission or non-transmission of a cell-specific reference signal, a multiplexing scheme, and a position of a resource block (RB) including the resource elements (REs).

2. The method according to claim 1, wherein:
if a physical downlink control channel (PDCCH) is not transmitted on the carrier, the resource elements (REs) mapped to the reference signal sequence is present not only in OFDM symbols (#1, #2) of a first slot, but also in OFDM symbols (#5, #6) of a second slot.

3. The method according to claim 2, wherein:
if transmission of a synchronous signal of the base station (BS) is carried out at the last OFDM symbol of a second slot,
the resource elements (REs) mapped to the reference signal sequence is present not only in OFDM symbols (#1, #2) of a first slot, but also in OFDM symbols (#2, #3) of a second slot.

4. The method according to claim 1, wherein:
if a physical downlink control channel (PDCCH) and the cell-specific reference signal are not transmitted on the carrier,
the resource elements (REs) mapped to the reference signal sequence is present not only in OFDM symbols (#0, #1) of a first slot, but also in OFDM symbols (#5, #6) of a second slot.

5. The method according to claim 4, wherein:
if transmission of a synchronous signal of the base station (BS) is carried out at the last OFDM symbol of a second slot,
the resource elements (REs) mapped to the reference signal sequence is present not only in OFDM symbols (#0, #1) of a first slot, but also in OFDM symbols (#4, #5) of a second slot.

6. The method according to claim 2, wherein:
a physical downlink shared channel (PDSCH) transmitted on a subframe including the resource elements (REs) is demodulated using the reference signal sequence.

7. The method according to claim 1, wherein the cell-specific reference signal is transmitted through an antenna port #0.

8. The method according to claim 1, wherein:
if a resource block (RB) including the resource elements (REs) corresponds to 6 resource blocks (6 RBs) located at the center part of the entire frequency band, the resource elements (REs) mapped to the reference signal sequence is present not only in OFDM symbols (#1, #2) of a first slot, but also in OFDM symbols (#2, #3) of a second slot.

9. The method according to claim 8, wherein:
if a resource block (RB) including the resource elements (REs) corresponds to the remaining resource blocks other than 6 resource blocks (6 RBs) located at the center part of the entire frequency band, the resource elements (REs) mapped to the reference signal sequence is present not only in OFDM symbols (#0, #1) of a first slot, but also in OFDM symbols (#5, #6) of a second slot.

10. The method according to claim 8, wherein:
specific information, that indicates that the position of RE mapped to the reference signal sequence is differently configured according to the position of a resource block (RB) including the resource elements (REs), is signaled to a user equipment (UE) to which the different configurations of the specific information are applied.

11. The method according to claim 1, wherein the resource elements (REs) mapped to the reference signal sequence is present not only in OFDM symbols (#1, #2) of a first slot, but also in OFDM symbols (#4, #5) of a second slot.

12. The method according to claim 1, wherein the resource elements (REs) mapped to the reference signal sequence is present not only in OFDM symbols (#0, #1) of a first slot, but also in OFDM symbols (#0, #1) of a second slot.

13. The method according to claim 1, wherein downlink control information (DCI) is transmitted only through an enhanced physical downlink control channel (E-PDCCH) on the carrier.

14. The method according to claim 1, wherein the carrier is a secondary component carrier (SCC).

15. A base station (BS) for use in a wireless communication system, comprising:
a transmission (Tx) module; and
a processor,
wherein the processor is configured to transmit a reference signal sequence mapped to a resource elements (REs) on a carrier,
wherein a position of RE mapped to the reference signal sequence is differently configured according to at least one of a carrier type, transmission or non-transmission of a cell-specific reference signal, a multiplexing scheme, and a position of a resource block (RB) including the resource elements (REs).
